(19) United States
(12) Patent Application Publication
(10) Pub. No.: US 2004/0164503 A1
(43) Pub. Date: Aug. 26, 2004

(54) Bit quick-release device

(76) Inventors: Wei-Chuan Fan-Chiang, Taichung Hsien (TW); Mu-Mau Tseng, Taichung Hsien (TW); Shih-Yueh Chen, Taichung Hsien (TW)

Correspondence Address: CHARLES E. BAXLEY, ESQUIRE, 59 John Street, Fifth Floor, New York, NY, 10038, US

(21) Appl. No.: 10/370,917

(22) Filed: Feb. 21, 2003

(51) Int. Cl. B23B 31/107

(52) U.S. Cl. 279/75

(57) ABSTRACT

A bit quick-release device includes a housing having a longitudinal hole in which a first spring and a plunger are respectively received therein. A damping member is located in the longitudinal hole and a radial hole is defined through a wall of the housing so as to receive a locking bead therein. A stop bush is movably mounted to the plunger and a limit ring is mounted to the plunger to prevent the plunger from moving further toward the first spring. A sleeve is movably mounted to the housing and a shoulder portion extends inward from an inner periphery of the sleeve. A second spring is mounted to the housing and biased between the shoulder portion and a stop ring mounted to an outside of the housing.

### FIELD OF THE INVENTION

The present invention relates to a quick-release device for screwdriver bits wherein the bit will not shoot out from the device when releasing it.

### BACKGROUND OF THE INVENTION

A conventional bit quick-release device 60 is shown in FIG. 6 and disclosed in U.S. Pat. No. 6,199,872. The conventional quick-release device 60 includes a housing 61 with a longitudinal hole 611 defined therein for receiving a spring 66 therein which is engaged between a stop 67 and a protrusion 651 of a plunger 65. A radial hole 612 is defined through a wall of the housing 61 and a locking bead 63 is movably engaged therewith. A sleeve 62 is movably mounted to the housing 61 and includes a shoulder portion 620 extending inward from in inner periphery of the sleeve 62. A spring 64 is mounted to the housing 61 and biased between the shoulder portion 620 of the sleeve 62 and a flange extending from an outer periphery of the housing 61. A tool bit 70 having a groove 71 is inserted in the longitudinal hole 611 and compresses the spring 66 while the sleeve 62 is pulled to compress the spring 64. The locking bead 63 is engaged with the groove 71 and when the sleeve 62 is released, the shoulder portion 620 pushes the locking bead 63 to securely engage with the groove 71 so that the tool bit 70 is positioned. When releasing the tool bit 70, the sleeve 62 is pulled and the locking bead 63 is not compressed by the shoulder portion 620. The tool bit 70 is pushed by the spring 66 so that the plunger 65 pushes the tool bit 70 out from the housing 61. The tool bit 70 may shoot out from the housing 61 because of the spring 66, and the sharp end of the tool bit 70 could hurt people. Besides, the force and the length of travel of the spring 66 change after the spring 66 is used for a period of time, and this affects the function of release of the tool bit 70.

The present invention intends to provide a quick-release device for bits wherein the bit is controlled to be released gently.

### SUMMARY OF THE INVENTION

In accordance with one aspect of the present invention, there is provided a bit quick-release device which comprises a housing having a longitudinal hole and a damping member is located in the longitudinal hole. A locking bead is movably engaged with a radial hole defined through a wall of the housing.

A first spring is received in the longitudinal hole and contacts against a closed second end of the housing. A plunger is received in the longitudinal hole and a stop bush is movably mounted to the plunger. A limit ring is mounted to the plunger and prevents the plunger from moving further toward the first spring. A first end of the plunger is fitted with an inner periphery of the longitudinal hole and pushes the locking bead outward. A second end of the plunger contacts the first spring.

A sleeve is movably mounted to the housing and a shoulder portion extends inward from an inner periphery of the sleeve. A second spring is mounted to the housing and biased between the shoulder portion and a stop ring mounted to an outside of the housing.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bit quick-release device of the present invention;

FIG. 2 is a cross sectional view to show the bit quick-release device of the present invention;

FIG. 3 is a cross sectional view to show the bit quick-release device of the present invention wherein the bit is positioned by the locking bead;

FIG. 4 is a cross sectional view to show the bit is pushed outward from the open end of the housing;

FIG. 5 is another embodiment of the quick-release device of the present invention, and

FIG. 6 shows a conventional bit quick-release device.

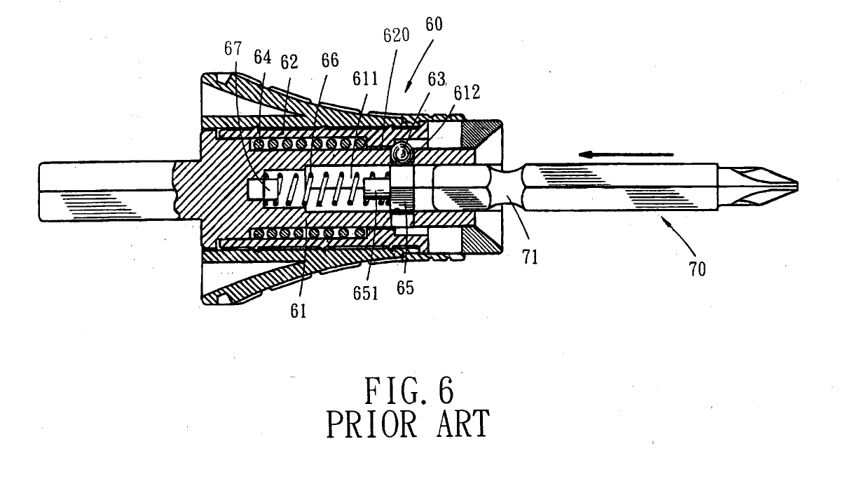

### DETAILED DESCRIPTION OF THE PREFERRED EMBODIMENT

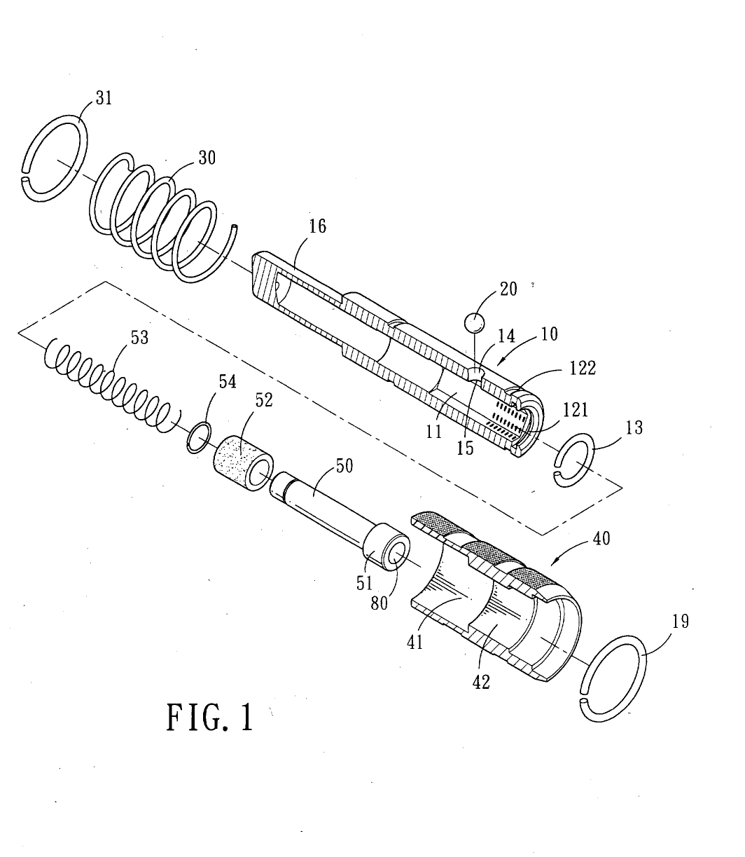

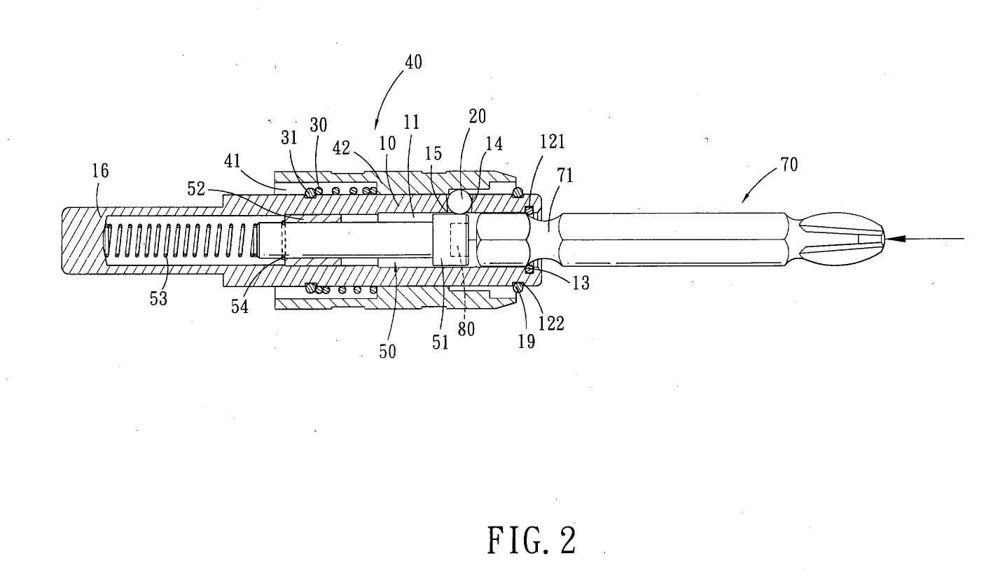

Referring to FIGS. 1 and 2, the bit quick-release device of the present invention comprises a housing 10 having a longitudinal hole 11 defined therein and communicating with an open end at a first end of the housing 10. A connection portion 16 is defined at a second end of the housing 10 so as to be connected with tool chuck or the like. A first groove 121 is defined in an inner periphery of the open end and a damping member such as a friction ring 13 is engaged with the first groove 121. A second groove 122 is defined in an outer periphery of the housing 10 and a ring 19 is engaged with the second groove 122. A radial hole 14 is defined through a wall of the housing 10 and includes a shrink neck portion 15 such that when a locking bead 20 is movably engaged with the radial hole 14, the locking bead 20 partially extends in the longitudinal hole 11.

A first spring 53 is received in the longitudinal hole 11 and contacts against the closed second end of the housing 10. A plunger 50 is received in the longitudinal hole 11 and a stop bush 52 is movably mounted to the plunger 50. A limit ring 54 is mounted to the plunger 50 and prevents the plunger 50 from moving further toward the first spring 53. A first end 51 of the plunger 50 has a magnet 80 connected thereto so as to easily attract the bit 70 inserted via the open end of the housing 10. A periphery of the first end 51 of the plunger 50 is fitted with an inner periphery of the longitudinal hole 11 and pushes the locking bead 20 outward when the bit 70 is not inserted. A second end of the plunger 50 contacts the first spring 53 which provides a force to push the bit 70 outward.

A sleeve 40 having a through passage 41 is movably mounted to the housing 10 and a shoulder portion 42 extends inward from an inner periphery of the sleeve 40 A second spring 30 is mounted to the housing 10 and biased between the shoulder portion 42 and a stop ring 31 mounted to an outside of the housing 10.

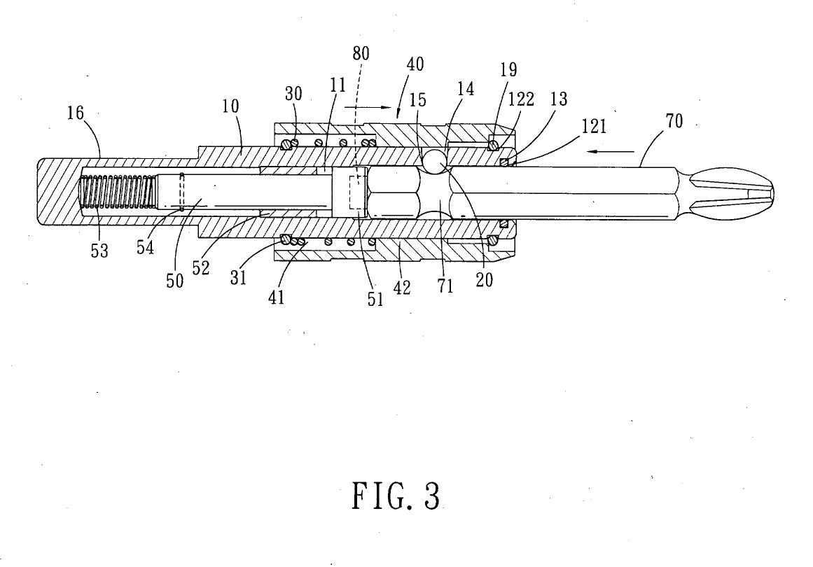

Referring to FIG. 3, when inserted the bit 70 in the housing 10, the sleeve 40 is pulled to compress the second spring 30 and the plunger 50 is pushed by the bit 70 and compresses the first spring 53 till the locking bead 20 is engaged with the groove 71 defined in an outer periphery of the bit 70. The sleeve 40 is released to let the shoulder portion 42 pushes the locking bead 20 to be firmly engaged with the groove 71. Therefore, the bit 70 is securely positioned in the housing 10.

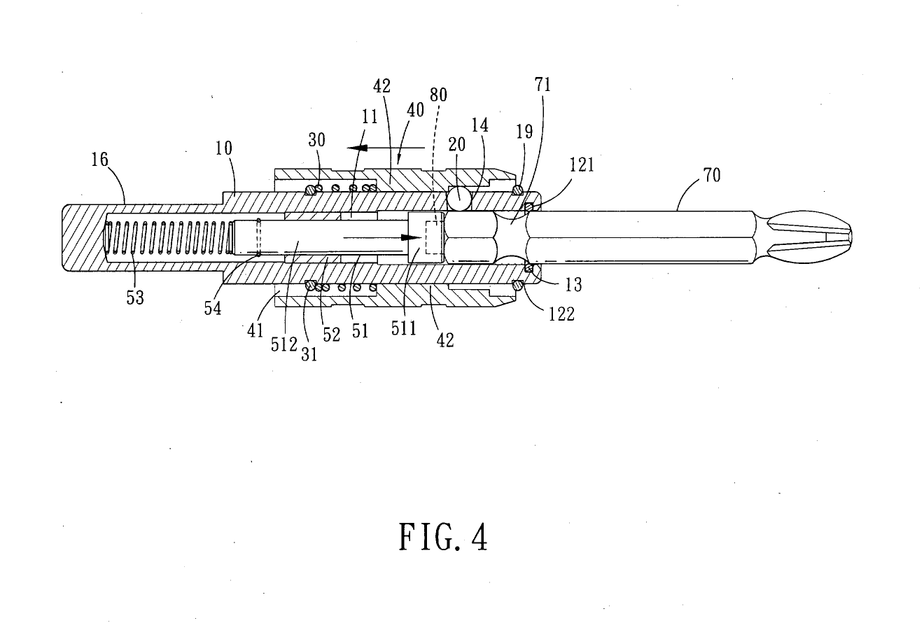

Referring to FIG. 4, when releasing the bit 70, the sleeve 40 is pulled again and the pressure on the locking bead 20 from the shoulder portion 42 is disappeared and the bit 70 is pushed outward by the first spring 53. The friction ring 13 and the stop bush 52 provide proper damping function to prevent the bit 70 from shooting out from the housing 10 while the bit 70 is attracted by the magnet 80, so that the user may easily take the bit 70 out.

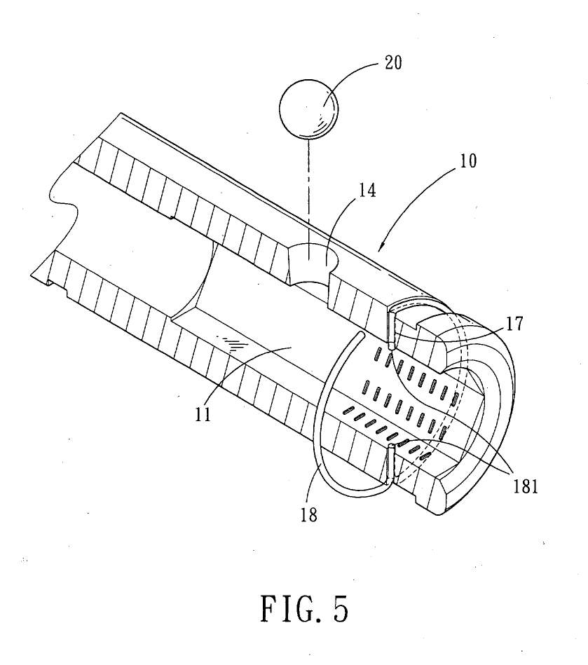

Referring to FIG. 5, the damping member may be composed of two clamps 18 each of which has an insertion 181 and two through hole 17 are defined through the wall of the housing 10 such that the insertions 181 are inserted in the through holes 17 and protrude into the longitudinal hole 11 in the housing 10.

While we have shown and described the embodiment in accordance with the present invention, it should be clear to those skilled in the art that further embodiments may be made without departing from the scope of the present invention.

What is claimed is:

1. A bit quick-release device comprising:
a housing having a longitudinal hole defined therein and communicating with an open end at a first end of the housing, a damping member located in the longitudinal hole and in the open end of the housing, a radial hole defined through a wall of the housing and a locking bead movably engaged with the radial hole;
a first spring received in the longitudinal hole and contacting against a closed second end of the housing, a plunger received in the longitudinal hole and a stop bush movably mounted to the plunger, a limit ring mounted to the plunger and preventing the plunger from moving further toward the first spring, a first end of the plunger fitted with an inner periphery of the longitudinal hole and pushing the locking bead outward, a second end of the plunger contacting the first spring, and
a sleeve movably mounted to the housing and a shoulder portion extending inward from an inner periphery of the sleeve, a second spring mounted to the housing and biased between the shoulder portion and a stop ring mounted to an outside of the housing.

2. The device as claimed in claim 1, wherein a magnet is connected to the second end of the plunger.

3. The device as claimed in claim 1, wherein a first groove defined in an inner periphery of the open end and the damping member which is a friction ring is engaged with the first groove.

4. The device as claimed in claim 1, wherein the damping member is at least one clamp which has at least one insertion and at least one through hole is defined through the wall of the housing such that the at least one insertion is inserted in the at least one through hole.
